(19) United States
(12) Patent Application Publication
(10) Pub. No.: US 2004/0261077 A1
(43) Pub. Date: Dec. 23, 2004

(54) Media processing apparatus and media processing method

(75) Inventors: Tomoaki Kozaki, Kyoto (JP); Masato Hirose, Osaka (JP); Yuki Kitamura, Kyoto (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/863,329

(22) Filed: Jun. 9, 2004

(30) Foreign Application Priority Data
Jun. 13, 2003 (JP) 2003-168821

(51) Int. Cl. G06F 9/46

(52) U.S. Cl. 718/104

(57) ABSTRACT

A media processing apparatus has an application processor having first and second applications and a media processor having an analyzing unit, a media module information holding unit, a music replay module, a voice conversation module, and an on-chip memory. Each of the modules has a plurality of operation modes and the analyzing unit performs switching to an optimum operation mode in response to a processing request from a user. This achieves optimum resource distribution during operation and allows a plurality of media processings to be performed in parallel.

The present application claims priority under 35 U.S.C. § 119(a) to Japanese Patent Application JP 2003-168821, the entire content of which is incorporated herein by reference.

### BACKGROUND OF THE INVENTION

1. Field of the Invention

The present invention relates to a media processing apparatus for processing media signals and a media processing method. More particularly, it relates to control for optimizing resource management when a plurality of media processings are performed in parallel.

2. Description of the Related Art

As media processing apparatus have been multifunctionalized in recent years, there have been increasing occasions on which a plurality of media processings are performed in parallel.

In a conventional media processing method which performs a single media signal processing, a sequences of processings executed by, e.g., a DSP (Digital Signal Processor) are divided into light processings which are executed every time a media signal sampled at a specified interval is inputted and heavy processings which are executed at a sufficiently large interval corresponding to an integral multiple of the interval between signal samplings. By constructing a media processing apparatus such that a heavy processing executed at the interval corresponding to an integral multiple of the interval between signal samplings is temporally divided into a plurality of sub-processings and executed in distributed relation, improvements in processing ability per single hardware of the DSP have been implemented (see, e.g., Japanese Laid-Open Patent Publication No. HEI 9-81542).

### SUMMARY OF THE INVENTION

However, the types of media processed by the media processing apparatus have increased and there have been increasing occasions on which a plurality of media processings are performed simultaneously by a single processing apparatus, as described above. As a result, there has been a growing need to improve a degree of parallelness by optimally using resources in the processing apparatus used for media processings.

The foregoing prior art technology constantly reserves a given amount of resources for each of media processings. In the case where a plurality of media processings are performed simultaneously in accordance with this method, it is accordingly necessary to constantly reserve an amount of resources which is the sum of maximum amounts of resources required by the individual media modules. However, it is a rare case where all the functions are performed in parallel even when a plurality of media processings are actually performed in parallel so that, in accordance with the conventional method, the reserved resources have not been used effectively. As a result, the processing ability of hardware has not been used satisfactorily.

The present invention has been achieved to solve the foregoing problems and it is therefore an object of the present invention to provide a media processing apparatus and a media processing method which allow optimum resource distribution when a plurality of media processings are performed in parallel.

A media processing apparatus according to the present invention comprises: a media processor having a plurality of media modules each for implementing a media processing function for each medium; and an application processor having an application for performing media processings by using the plurality of media modules, wherein at least one of the plurality of media modules has a plurality of operation modes and the media processor has: a media module information holding unit for holding in-use resource information in each of the operation modes of the plurality of media modules and required resource information in accordance with processing data information; and an analyzing unit for acquiring, upon operation, the processing data information from the application, acquiring the in-use resource information and the required resource information from the media module information holding unit, selecting the operation mode of each of the media modules based on information acquired by examining idle resource information, and directing switching to the selected operation mode.

Since this allows the switching of the combination of operation modes of each of the media modules in response to a processing request from the user or the like, it becomes possible to optimize resource distribution and perform a plurality of media processings in parallel without delay.

The media processor further has an on-chip memory as an operation region for performing the media processings and the in-use resource information and the required resource information may include information on a capacity of the on-chip memory.

The in-use resource information and the required resource information may include information on a load on the media processor. Alternatively, the in-use resource information and the required resource information may also include resource information on an external memory.

The analyzing unit has, for each of the media modules, priority information when the mode is switched and determines a priority with which the operation mode is switched based on the priority information. The arrangement can prevent the lowering of the processing ability. For example, if a higher priority has been given to the media module which is small in overhead when the operation mode is switched, the overhead is less likely to occur in the processing when the operation mode is switched so that the lowering of the processing ability is prevented effectively.

A media processing method according to the present invention uses a media processing apparatus comprising: a media processor having a plurality of media modules each for implementing a media processing function for each medium, a media module information holding unit for holding in-use resource information in each of operation modes of the plurality of media modules and required resource information in accordance with processing data information, and an analyzing unit; and an application processor having an application for performing media processings by using the plurality of media modules, the media processing method comprising the steps of: (a) causing the analyzing unit to acquire the processing data information; (b) causing the analyzing unit to acquire the in-use resource information and the required resource information; (c) causing the analyzing unit to select candidate operation modes for a switching target from within the media modules based on information acquired by examining idle resources; and (d) causing the analyzing unit to select the operation mode from among the candidate operation modes for a switching target and direct switching to the selected mode.

Since the method allows proper switching of the operation mode during operation, resource distribution is performed depending on the situation and the resources can be used effectively. As a result, it becomes possible to perform a plurality of media processings in parallel. It becomes also possible to optimize resource distribution and reduce power consumption.

The steps (a), (b), (c), and (d) are repeated for each of the media modules. The arrangement allows the processing to be performed in a shorter period of time than in the case of repeating the steps (a) to (c) for each of the media modules.

The step (d) is performed after the steps (a), (b), and (c) are performed for each of the plurality of media modules. This makes it possible to preliminarily assign all the combinations of operation modes as candidates and select an optimum combination of operation modes.

The analyzing unit has, for each of the plurality of media modules, priority information when the mode is switched and determines a priority with which the operation mode is switched based on the priority information. By giving a higher priority to the media module less likely to suffer overhead upon switching, e.g., the lowering of the processing ability can be prevented.

The media processing apparatus further has: a storage device for holding a program, wherein the program may implement the steps (a), (b), (c), and (d) by using a computer.

### BRIEF DESCRIPTION OF THE DRAWINGS

FIG. 1 is a block diagram showing a media processing apparatus according to a first embodiment of the present invention;

FIG. 2 is a view showing resource information on a music replay module and a voice conversation module;

FIG. 3 is a view showing information on the types of formats of stream information and the bit rates thereof;

FIG. 4 is a flow chart diagram illustrating a media processing method according to the present invention;

FIG. 5 is a flow chart diagram illustrating the procedure for collecting resource information in each of media processing methods according to the first and second embodiments of the present invention;

FIG. 6 is a flow chart diagram illustrating the procedure for selecting an operation mode from among candidate operation modes in each of the media processing methods according to the first and second embodiments;

FIG. 7 is a view showing the switching of operation modes in the music replay module and the voice conversation module in the media processing method according to the first embodiment;

FIG. 8 is a flow chart diagram illustrating a media processing method according to a specific example of the first embodiment;

FIG. 9 is a block diagram showing a structure of a media processing apparatus according to the second embodiment;

FIG. 10 is a flow chart diagram illustrating the media processing method according to the second embodiment;

FIG. 11 is a flow chart diagram illustrating a media processing method according to a third embodiment of the present invention;

FIG. 12 is a flow chart diagram illustrating the procedure for collecting resource information in the media processing method according to the third embodiment; and

FIG. 13 is a flow chart diagram illustrating the procedure for selecting an operation mode from among candidate operation modes in the media processing method according to the third embodiment.

### DETAILED DESCRIPTION OF THE INVENTION

Referring to the drawings, the individual embodiments of the present invention will be described herein below. Although a description will be given to a voice conversation with another apparatus using the replay and recording of music and a wireless system as an example of a media processing, the media processing is not limited thereto and may also be the replay of a videotaped material or a CG processing.

Embodiment 1

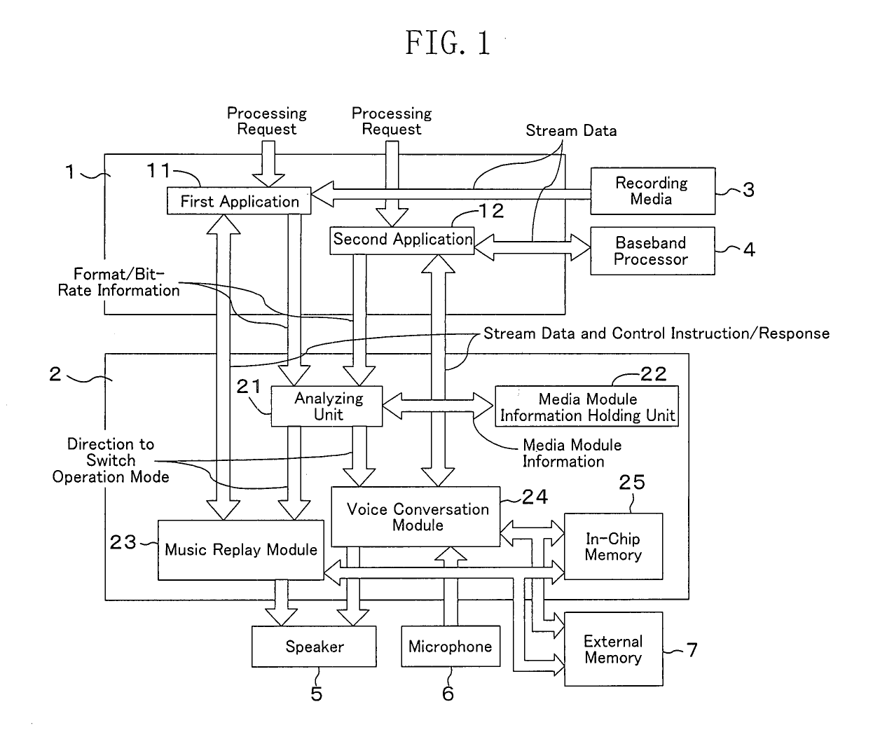

FIG. 1 is a block diagram showing a media processing apparatus according to the first embodiment of the present invention. As an example of the media processing apparatus shown herein, a mobile phone or the like can be listed.

As shown in FIG. 1, the media processing apparatus according to the present embodiment comprises: an application processor 1 for processing stream data inputted thereto; a media processor 2 for performing media processings based on an instruction from the application processor; a recording medium 3 which is a nonvolatile memory; a baseband processor 4 for performing processings associated with, e.g., communication and conversation; a speaker 5; a microphone 6; and an external memory 7.

The application processor 1 has one or more applications to perform data transmission and reception between the recording medium 3 and the baseband processor 4 upon receipt of a processing request from a user and control the media processor 2. In the example shown in FIG. 1, the application processor 1 contains a first application 11 and a second application 12. The first application 11 and the second application 12 control a music replay module 23 and a voice conversation module 24 in the media processor 2, respectively, and thereby implements media processings.

The media processor 2 has an analyzing unit 21, a media module information holding unit 22, an on-chip memory 25, and a plurality of media modules to perform arithmetic operations for media processings and control hardware devices. In the example shown in FIG. 1, the media processor 2 contains the music replay module 23 and the voice conversation module 24.

The recording medium 3 is a nonvolatile memory for storing stream data necessary for media processings and the like.

The baseband processor 4 is a processor for communicating with another apparatus by using a wireless system.

The speaker 5 outputs voice data received from the media processor 2.

The microphone 6 outputs the acquired voice data to the media processor 2.

The external memory 7 is a work memory used by the media modules.

The media module information holding unit 22 holds the following two types of information.

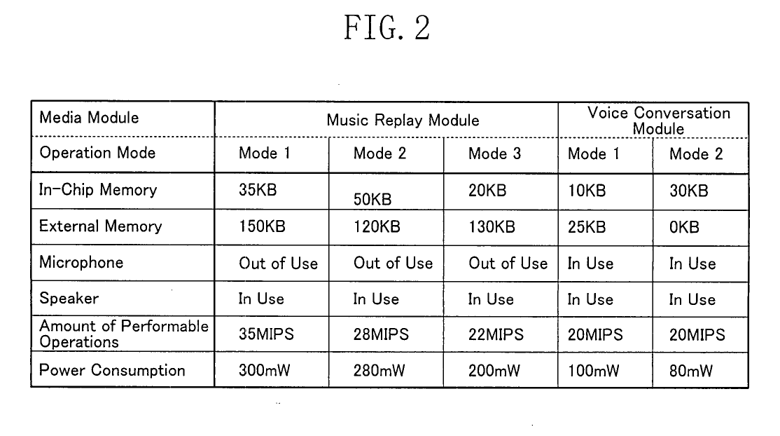

The media module information holding unit 22 holds information on resources which are used by the individual media modules in operation for each of the operation modes thereof in such formats as shown in FIG. 2. Each of the media modules has prepared a plurality of combinations of resources used thereby and each of the combinations is termed an operation mode.

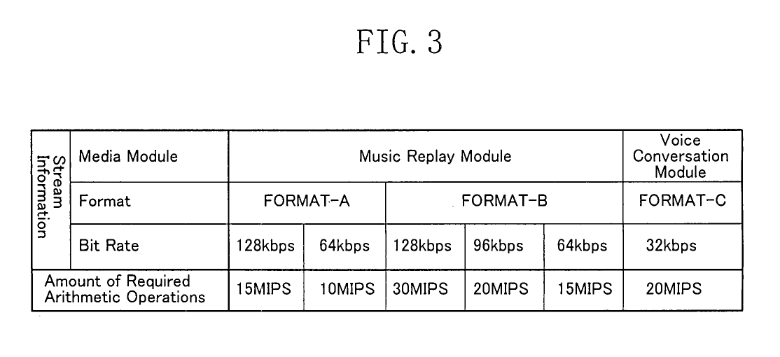

The media module information holding unit 22 also holds information on amounts of arithmetic operations required by the individual media modules in operation for each of the types of data formats of stream data processed by the media module and each of the bit rates thereof in such formats as shown in FIG. 3. In the present specification, the information is termed processing data information.

FIG. 2 is a view showing resource information on the music replay module and the voice communication module. FIG. 3 is a view showing information on the types of formats of stream information and the bit rates thereof. FIG. 2 shows, for each of the modes, information including respective memory spaces required of the on-chip memory and the external memory, the presence or absence of the use of each of the microphone and the speaker, an amount of performable arithmetic operations (an amount of CPU resources to be used), and power consumption. FIG. 3 also shows an amount of required arithmetic operations in addition to the information on the types of formats and the bit rates.

The analyzing unit 21 receives information on the types of data formats and the bit rates, the in-use resource information, and the required resource information from the first and second applications 11 and 12 and from the media module information holding unit 22, determines an operation mode optimum for the media module in operation based on the information, and directs the music replay module 23 and the voice conversation module 24 to change the mode. The processing flow of determining the operation mode in the analyzing unit 21 will be described later in detail.

The plurality of media modules are present in the media processor 2 and can be operated in parallel depending on the situation. The media processor 2 according to the present embodiment has the music replay module 23 for replaying music data stored in the recording medium 3 by using the speaker 5 and the voice conversation module 24 for having a voice conversation with another apparatus via a wireless system by using the baseband processor 4, the speaker 5, and the microphone 6.

Each of the media modules is controlled by the corresponding one of the applications in the application processor 1 and performs arithmetic operations for a media processing.

If necessary, the individual media modules can be connected to the different hardware devices of the speaker 5 and the microphone 6 to use these hardware devices. In the media processing apparatus according to the present embodiment, the music replay module 23 is connected to the speaker 5 and the voice conversation module 24 is connected to the speaker 5 and the microphone 6.

The first application 11 in the application processor 1 receives a processing request from the outside, extracts music stream data from the recording medium 3, and transmits the stream data and a control instruction to the music replay module 23, thereby controlling the music replay module 23 and causing the speaker 5 to replay music.

On the other hand, the second application 12 receives a processing request from the outside, controls the voice conversation module 24, processes voice stream data from the baseband processor 4, and causing the speaker 5 to replay the processed data, while processing the voice data from the microphone 6 and sending it to the baseband processor 4.

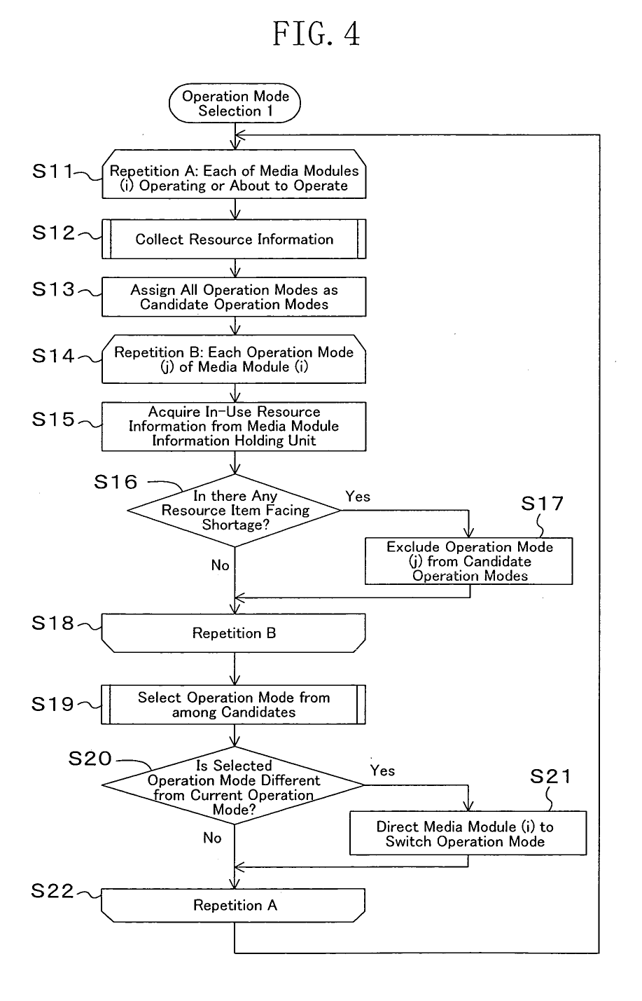

A description will be given next to the processing flow of determining the operation mode in the analyzing unit 2 by using the flow charts shown in FIGS. 4, 5, and 6.

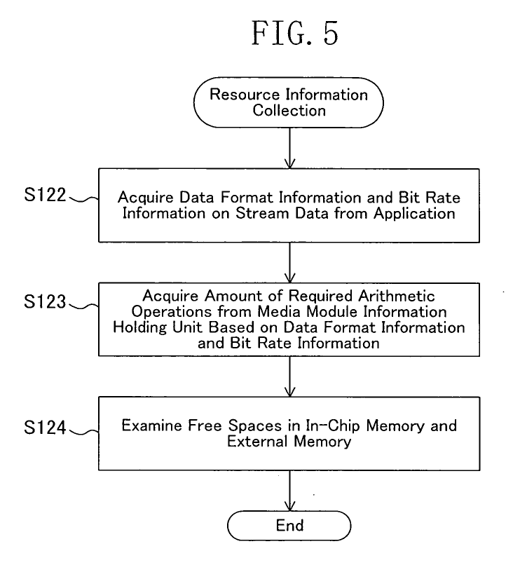

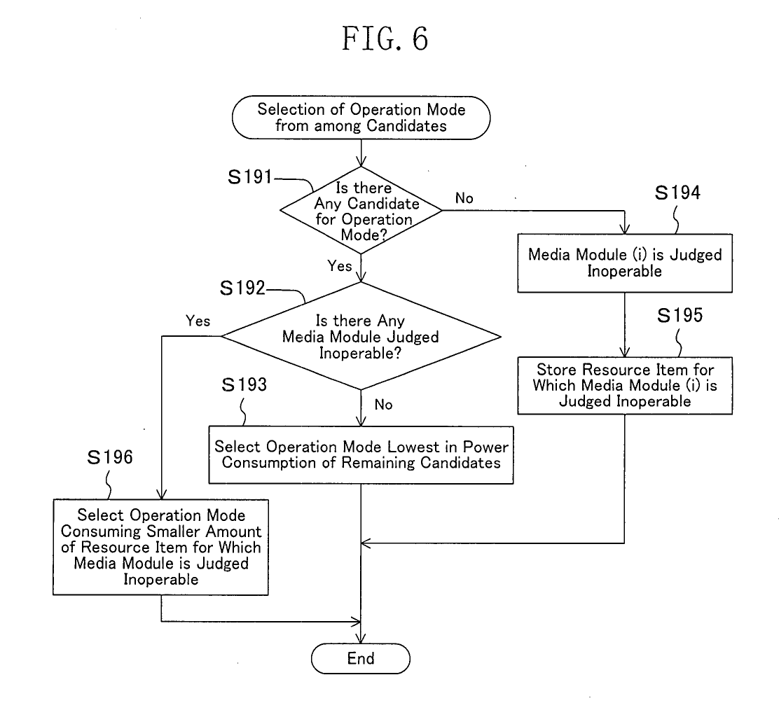

FIG. 4 is a flow chart diagram illustrating a media processing method according to the present embodiment. FIG. 5 is a flow chart diagram illustrating the procedure for collecting the resource information in the media processing method. FIG. 6 is a flow chart diagram illustrating the procedure for selecting an operation mode from among candidate operation modes in the media processing method.

The determination of the operation mode is repeatedly performed with respect to each of the media modules in operation in response to a change in stream information obtained from the application or to a situational change such as the activation or halt of the media module. The procedure from Step S11 to Step S22 is repeated depending on the situation (Repetition A) and Steps S14 to S18 are also repeated if necessary (Repetition B).

First, in Step S11 shown in FIG. 4, switching of the operation mode is started in response to a change in stream information or a situational change in the media module. The processing from Step S11 to Step S22 is performed for each of the media modules.

Subsequently, in Step S12, the analyzing unit 21 collects the resource information. The step of collecting the resource information consists of a plurality of steps shown in FIG. 5.

First, in Step S122, the analyzing unit 21 acquires information on the type of the data format of stream data and the bit rate thereof from the application.

Next, in Step S123, the analyzing unit 21 acquires information on an amount of arithmetic operations required upon operation from the media module information holding unit 22 by using the acquired information on the type of the data format and the bit rate thereof.

Next, in Step S124, the analyzing unit 21 examines the on-chip memory 25 and the external memory 7 and acquires information on respective free memory spaces therein. By the foregoing procedure, the resource information is collected.

Next, in Step S13 shown in FIG. 4, all the operation modes are temporarily assigned as candidate operation modes for the target media module.

Subsequently, in Step S14, the following processing is performed for each of operation modes.

That is, in Step S15, the analyzing unit 21 acquires, from the media module information holding unit 22, the in-use resource information on each of the operation modes of the media module.

Next, in Step S16, the analyzing unit 21 judges whether or not the individual resources of the amount of arithmetic operations, the on-chip memory, and the external memory include any item facing a shortage as a result of selecting the operation mode. If there is any resource item facing a shortage, the processing flow advances to Step S17. If there is none, the processing flow advances to Step S18.

In Step S17, the operation mode for which a resource shortage has been detected in Step S16 is excluded from the candidate operation modes and the processing flow advances to Step S18.

Next, in Step S18, the processing flow returns to Step S14 where another operation mode is examined. The procedure from Step S14 to Step S18 is repeated until each of the operation modes is examined.

Next, in Step S19, an operation mode as a switching target is selected from among the candidate operation modes after the processing from Step S14 to Step S18 is completed for each of the operation modes in the selected media module. The step includes Steps S191 to S196.

First, in Step S191 shown in FIG. 6, it is judged whether or not there is any candidate operation mode. If there is any candidate, the processing flow advances to Step S192. If there is none, the processing flow advances to Step S194.

Next, in Step S192, the analyzing unit 21 judges whether or not there is any media module judged to be inoperable due to a resource shortage. If there is any media module judged to be inoperable, the processing flow advances of Step S196. If there is none, the processing flow advances to Step S193.

Next, in Step S193, that one of the remaining candidate operation modes which is the lowest in power consumption is selected as an optimum operation mode. Although the present embodiment has given the top priority to a reduction in power consumption, the operation mode may also be selected such that the top priority is given to an item other than that, e.g., sound quality.

If there is any media module that has been judged previously inoperable due to a resource shortage in Step S196, an operation mode which consumes the resource item that has caused inoperability in a smaller amount is selected.

In Step S194, on the other hand, the analyzing unit 21 judges that the media module examined by the present procedure is inoperable.

Subsequently, in Step S195, the resource item for which the media module is judged to be inoperable in Step S194 is stored in the analyzing unit 21.

After the foregoing steps, the processing flow advances to Step S20 shown in FIG. 4.

In Step S20, the analyzing unit 21 judges whether or not the operation mode selected in Step S19 is different from the currently operating mode. If the selected operation mode is identical with the currently operating mode, the processing flow advances to Step S22. If it is different, the processing flow advances to Step S21.

In Step S21, the analyzing unit 21 directs the media module to switch to the selected operation mode. Then, the processing flow advances to Step S22.

Next, in Step S22, the processing flow advances again to Step S11 and the foregoing procedure from Step S11 to Step S21 is repeated for another media module.

Since the foregoing method allows proper resource redistribution, it becomes possible to perform a plurality of media processings in parallel.

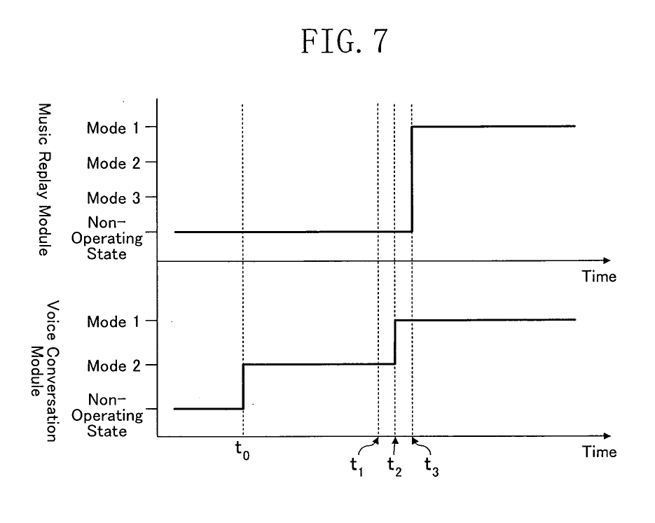

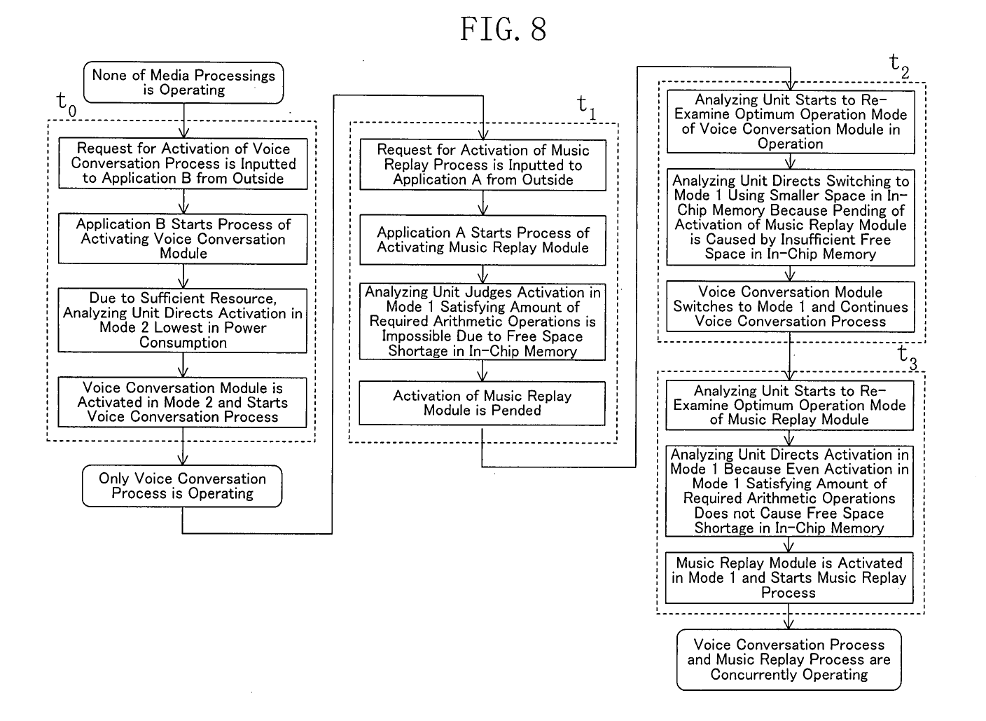

A specific example of the operation when the operation mode is switched will be described in order with reference to FIGS. 7 and 8.

FIG. 7 is a view showing the switching of the operation modes in the music replay module and the voice conversation module. FIG. 8 is a flow chart diagram illustrating the processing in the present specific example. The present specific example will be described with reference to these drawings. It is assumed herein that simultaneous use of the speaker 5 (see FIG. 1) by the plurality of media modules is permitted and that the respective total capacities of the on-chip memory and the external memory are 64 KB and 512 KB.

It is assumed that, at the time to, the second application 12 has first activated the voice conversation module 24 in response to a processing request from the outside.

At this time, the analyzing unit 21 analyzes an optimum operation mode along the foregoing processing flow of determining an operation mode. However, since there is no other media module operating and resources such as the memories are sufficient, “Operation Mode 2” shown in FIG. 2 which is lower in power consumption is selected in Step S193. In the on-chip memory, a free space of 30 KB is consumed by the voice conversation module 24 which has started operation in “Operation Mode 2” and the speaker 5 and the microphone 6 are brought into an in-use state.

Next, it is assumed that, at the time t₁, the first application 11 has attempted to activate the music replay module 23 to replay music data at 128 kbps in the FORMAT-B shown in FIG. 3 in response to a processing request from the outside, while the voice conversation module 24 is still operating.

At this time, the analyzing unit 21 reads an amount of required arithmetic operations, which is 30 MIPS, from the information on an amount of arithmetic operations (FIG. 3) held in the media module information holding unit 22 in Step S123 so that the modes other than “Operation Mode 1” shown in FIG. 2 are excluded from the candidate operation modes in Step S16 due to an insufficient amount of performable arithmetic operations.

However, since the voice conversation module 24 is still operating in the operation mode 2 and using 30 KB in the on-chip memory, the free space in the on-chip memory is 34 KB. As a result, the operation mode 1 is also excluded from the candidate operation modes since 35 KB used in the operation mode 1 of the music replay module 23 cannot be reserved.

Accordingly, the voice conversation module is temporarily judged to be inoperable in Step S194 and a free space shortage in the on-chip memory is stored in Step S195.

However, the analyzing unit 21 attempts to switch the operation mode of the voice conversation module 24 already in operation at the subsequent time t₂, selects “Operation Mode 1” which uses a smaller amount of space in the on-chip memory because there are media modules that have been judged previously inoperable in Steps S192 and 196 due to a free space shortage in the on-chip memory, and directs the switching of the mode. Thus, the voice conversation module 24 is switched from “Operation Mode 2” to “Operation Mode 1” at the time t₂ in response to the direction from the analyzing unit 21.

Although an amount of space occupied in the external memory is increased to 25 KB by the voice conversation module 24 which has started operation in “Operation Mode 1”, an amount of space occupied in the on-chip memory decreases from 30 KB to 10 KB and there is no change in the use state of the speaker 5 and the microphone 6. Accordingly, the size of a free space in the on-chip memory increases from 34 KB to 54 KB.

Next, at the time t₃, the analyzing unit 21 once again selects the operation mode of the music replay module 23. Since the size of a free space in the on-chip memory has increased, “Operation Mode 1” remains as a candidate this time and is selected so that the music replay module 23 starts operation.

The voice conversation module 24 operating in “Operation Mode 1” and the music replay module 23 that has started operation in “Operation Mode 1” consume 45 KB in the on-chip memory and 25 KB in the external memory so that the speaker 5 is brought into a state shared by the two media modules and the microphone 6 is brought into an in-use state.

By thus dynamically switching the operation mode of the media module, dynamic resource redistribution is performed and it becomes possible to operate the plurality of media modules in parallel.

Although the foregoing description has used the amount of arithmetic operations and the memory capacities as the resource information used by the analyzing unit 21 to select the optimum operation mode, it is also possible to dynamically change the operation mode which allows optimum resource redistribution in the same manner even if information on the load factor of the media processor is used in addition to these.

Although the example having such a hardware structure as shown in FIG. 1 has been described as the media processing apparatus according to the present embodiment, it is also possible to cause a processor to perform the same processing as performed by the media processing apparatus according to the present embodiment by using software programmed with the respective operations of the applications, the analyzing unit, and the media modules. Such a program may be recorded appropriately in, e.g., a ROM outside the apparatus or the like.

Although the analyzing unit 21 has acquired the processing data, selected the operation mode of the media module, and directed switching to the selected operation mode in the media processing apparatus according to the present embodiment, these operations may also be performed by other components.

Embodiment 2

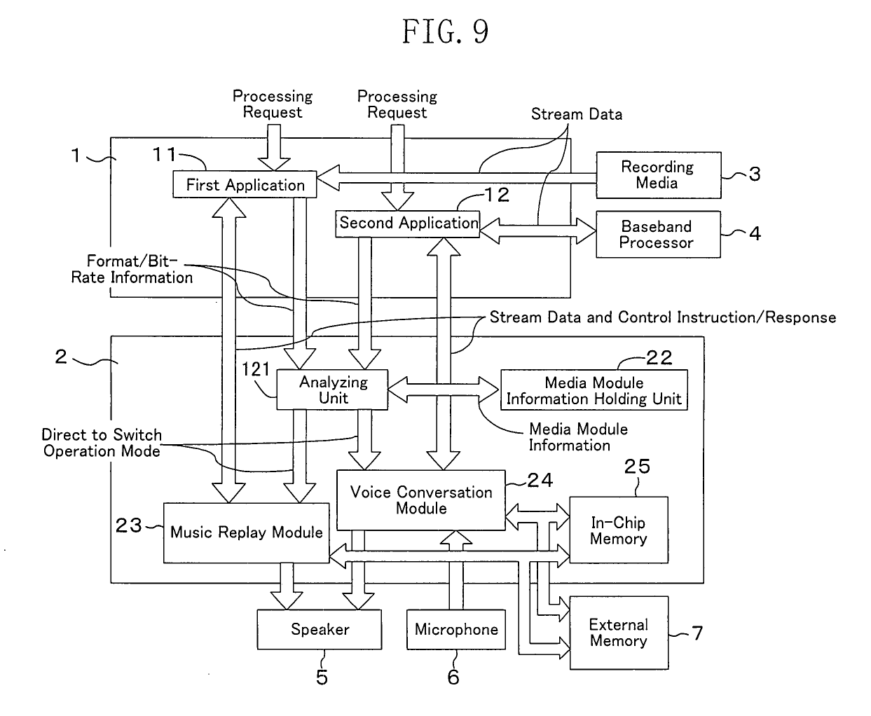

FIG. 9 is a block diagram showing a structure of a media processing apparatus according to the second embodiment of the present invention.

As shown in the drawing, the media processing apparatus according to the present embodiment is the same as the media processing apparatus according to the first embodiment in that it comprises: the application processor 1; the media processor 2; a recording medium 3 which is a nonvolatile memory; the baseband processor 4; the speaker 5; the microphone 6; and the external memory 7, except for an analyzing unit 121 added to the media processor 2 in place of the analyzing unit 21. A description will be given herein only to the features different from those of the media processing apparatus according to the first embodiment.

First, the analyzing unit 121 holds priorities given to the individual media modules concerning the switching of the operation mode.

A method for determining the operation mode in the analyzing unit 121 will be described with reference to the flow charts shown in FIGS. 5, 6, and 10.

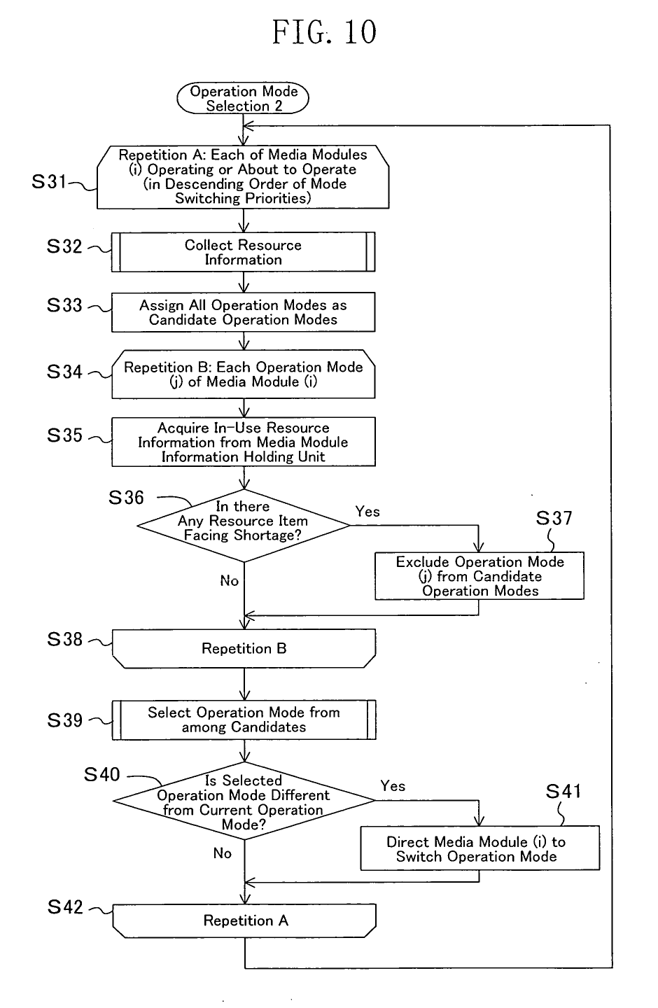

FIG. 10 is a flow chart diagram illustrating a media processing method according to the present embodiment.

The analyzing unit 121 repeats the following processing from Step S31 to Step S42 for each of the media modules in operation. It is assumed herein that the processing is repeated for the media modules in descending order of mode switching priorities given thereto such that the operation mode of the media module with a higher priority is switched earlier.

First, in Step S31, the switching of the operation mode is started in response to a change in stream information or a situational change in the media module.

Then, the analyzing unit 121 acquires resource information from the media module information holding unit 22, similarly to the analyzing unit 21. This step is the same as in the resource processing method according to the first embodiment shown in FIG. 5.

Next, in Steps S33 and S34, the following processing is performed for each of the operational modes by temporarily assigning all the operation modes as candidate operation modes for the target media module.

Then, in Step S35, the analyzing unit 121 acquires, from the media module information holding unit 22, the resource information on each of the operation modes of the media module.

Next, in Step S36, the analyzing unit 121 examines whether or not the individual resources of the amount of arithmetic operations, the on-chip memory, and the external memory include any item facing a shortage as a result of selecting the operation mode. If there is any resource item facing a shortage, the processing flow advances to Step S37. If there is none, the processing flow advances to Step S38.

Next, in Step S37, the operation mode for which a resource shortage has been detected in Step S36 is excluded from the candidate operation modes and the processing flow advances to Step S38.

Next, in Step S38, the processing flow returns to Step S34 where another operation mode is examined. The procedure from Step S34 to Step S38 is repeated until each of the operation modes is examined.

Next, in Step S39, an optimum operation mode is selected from among the candidate operation modes after the processing from Step S34 to Step S38 is completed for each of the operation modes.

Next, in Step S40, the analyzing unit 121 judges whether or not the operation mode selected in Step S39 is different from the currently operating mode. If the selected operation mode is identical with the currently operating mode, the processing flow advances to Step S42. If it is different, the processing flow advances to Step S41.

Next, in Step S41, the analyzing unit 121 directs the media module to switch to the selected operation mode, interrupts the processing to the media module which is lower in mode switching priority than this media module, and resumes the processing by changing the processing target to a media module higher in priority. When the switching of the operation mode has occurred in Step S40, the mode switching frequency of the media module higher in mode switching priority can be set higher than that of the media module lower in mode switching priority by thus getting out of the repetition.

A method for determining the priorities is not particularly defined. For example, there is a method which gives a higher priority to a media module which is smaller in overhead when the operation mode is switched. The method lowers the frequency with which the switching of the mode is directed to the media module which is large in overhead when the operation mode is switched and thereby prevents the lowering of the processing ability.

Embodiment 3

As the third embodiment of the present invention, a media processing method which performs a processing different from that performed in the first embodiment by using the media processing apparatus according to the first embodiment will be described.

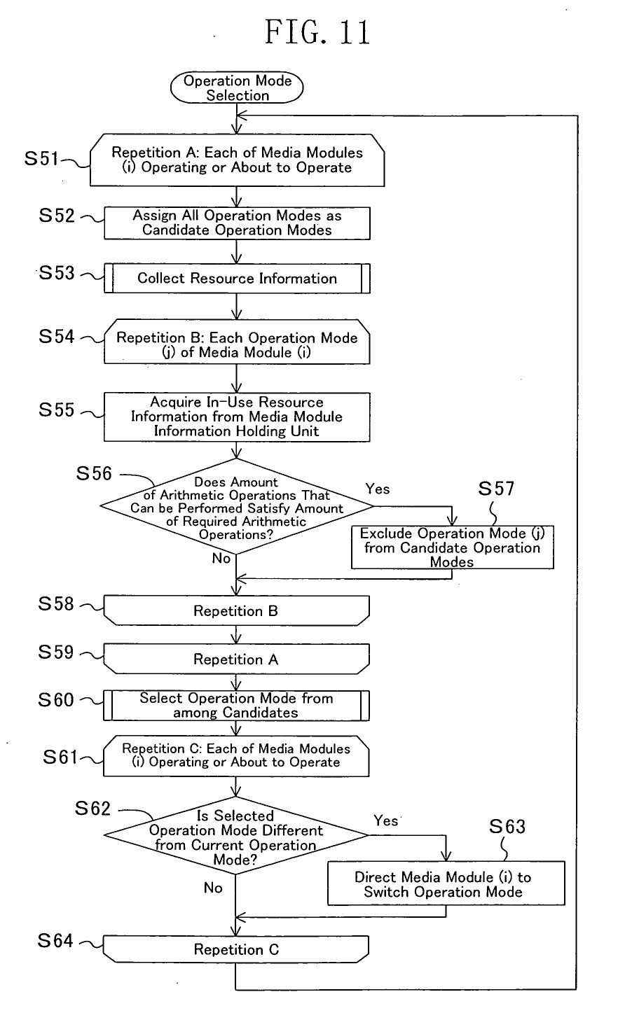

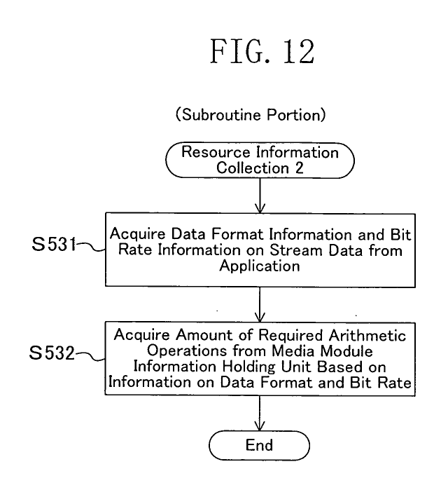

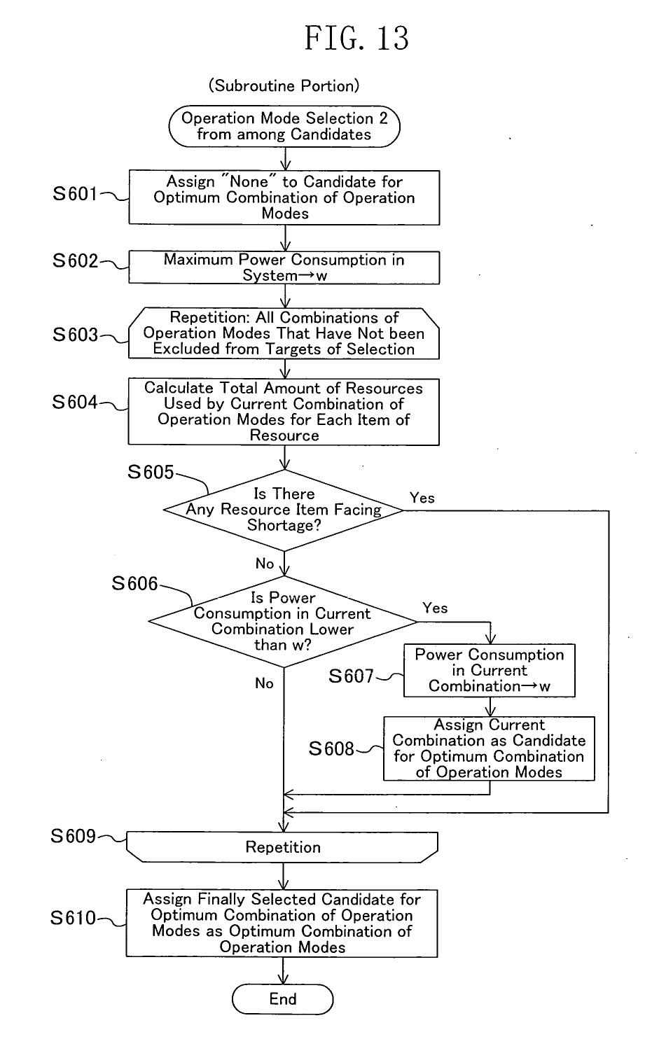

FIG. 11 is a flow chart diagram illustrating the media processing method according to the third embodiment. FIG. 12 is a flow chart diagram illustrating the procedure for collecting resource information in the media processing method according to the present embodiment. FIG. 13 is a flow chart diagram illustrating the procedure for selecting an operation mode from among candidate operation modes in the media processing method according to the present embodiment.

First, in Step S51 shown in FIG. 11, switching of the operation mode is started in response to a change in stream information or a situational change in the media module.

Subsequent, in Step S52, the following processing is performed by regarding all the operation modes of the selected media module as candidate operation modes.

Then, in Step S53, the analyzing unit 21 collects the resource information. The step of collecting the resource information consists of a plurality of steps shown in FIG. 12.

First, in Step S531, the analyzing unit 21 acquires information on the type of the data format of stream data and the bit rate thereof from the application.

Next, in Step S532, the analyzing unit 21 acquires information on an amount of arithmetic operations required upon operation from the media module information holding unit 22 by using the acquired information on the type of the data format and the bit rate thereof. Since the media processing method according to the present embodiment simultaneously examines all the combinations of operation modes of all the media modules that are operating or about to operate to determine an optimum combination, it is unnecessary to examine free spaces in the memories at this time point.

Next, in Step S54, the following processing will be performed for each of the operation modes.

That is, in Step S55, the analyzing unit 21 acquires in-use resource information on each of the operation modes of the media modules from the media module information holding unit 22.

Next, in Step S56, the analyzing unit 21 judges whether or not an amount of performable arithmetic operations in the operation mode satisfies an amount of required arithmetic operations. If the amount of performable arithmetic operations satisfies the amount of required arithmetic operations, the processing flow advances to Step S58. If it does not, the processing flow advances to Step S57.

In Step S57, the operation modes which did not satisfy the amount of required arithmetic operations in Step S56 are excluded from the candidate operation modes and the processing flow advances to Step S58.

Next, in Step S58, the processing flow returns to Step S54 and another operation mode is examined. The procedure from Step S54 to Step S58 is repeated until each of the operation modes is examined.

Then, in Step S59, the processing flow advances again to Step S51 where the processing from Step S51 to Step S58 is repeated for the operation modes of another media module, which makes the processing method according to the present embodiment different from that according to the first embodiment. In contrast to the first embodiment which has selected an optimum operation mode for each of the media modules and then examined another media module, the method according to the present embodiment preliminarily examines the operation modes of all the media modules and then selects an optimum operation mode from among all the operation modes.

Next, in Step S60, the operation mode as the switching target is selected from among the candidate operation modes after the processing from Step S51 to Step S59 is completed for all the operation modes in all the media modules. In the present step, only one optimum combination of operation modes is determined for the media modules which are operating or about to operate.

Step S60 includes Steps S601 to S610 shown in FIG. 13.

First, in Step S601, “None” is assigned as a candidate for an optimum combination of operation modes.

Then, in Step S602, the analyzing unit 21 calculates maximum power consumption w in the system. The maximum power consumption w is a variable indicative of the lowest ever one of powers consumed in the combinations of operation modes that have been examined thus far.

Subsequently, in Step S603, all the combinations of operation modes which have not been excluded from the targets of selection in Step S57 are examined.

Then, in Step S604, the analyzing unit 21 calculates the total amount of resource used in the current combination for each resource item.

Subsequently, in Step S605, the analyzing unit 21 judges whether or not there is any resource item facing a shortage as a result of the calculation. If there is any resource item facing a shortage, the processing flow advances to Step S609. If there is none, the processing flow advances to Step S606.

Next, in Step S606, it is judged whether or not the power consumed in the current combination of operation modes is lower than the maximum power consumption w. If the consumed power is lower than the maximum power consumption w, the processing flow advances to Step S607. If the consumed power is equal to the maximum power consumption w, the processing flow advances to Step S609.

Then, in Step S607, the analyzing unit 21 calculates the power consumption w in the current combination of operation modes.

Subsequently, in Step S608, the current combination of operation modes is assigned as a candidate for the optimum combination of operation modes. Thereafter, the processing flow advances to Step S609.

Next, in Step S609, the processing flow advances again to Step S603 and the processing from Step S604 to Step S608 is repeated for another combination of operation modes. In this case, the maximum power consumption w is updated every time a combination of operation modes lower in power consumption is found in the repetition of Steps S604 to S608.

Then, in Step S610, a candidate for the optimum combination of operation modes finally selected is assigned as the optimum combination of operation modes after each of the combinations of operation modes selected in Step S56 is examined. In the present embodiment, the combination of operation modes finally selected is lowest in power consumption. After the foregoing processing, the processing flow advances to Step S61.

Next, in Step S61, the following processing is performed with respect to each of the media modules which are currently operating or about to operate.

That is, it is judged in Step S62 whether or not the operation mode selected before the preceding Step S61 is different from the current operation mode. If the selected operation mode is different from the currently operation mode, the processing flow advances to Step S63. If the selected operation mode is the same as the currently operating mode, the processing flow advances to Step S64.

Next, in Step S64, the processing flow advances again to Step S61 where the processing is repeated. Here, Steps S61 to S64 are repeated by the number of times equal to the number of media modules which are operating or about to operate.

Thus, the media processing method according to the present embodiment determines the optimum combination of operation modes after assigning the operation modes contained in all the media modules as the targets of selection. Accordingly, the optimum combination of operation modes can be determined more reliably than in accordance with the media processing method according to the first embodiment. Since the present embodiment has adopted power consumption as the criterion for selecting the operation mode in Step S606, it becomes possible to execute an operation mode lower in power consumption as required.

It is also possible to adopt an item other than power consumption as the criterion for selection as required.

What is claimed is:

1. A media processing apparatus comprising:
a media processor having a plurality of media modules each for implementing a media processing function for each medium; and
an application processor having an application for performing media processings by using the plurality of media modules, wherein
at least one of the plurality of media modules has a plurality of operation modes and
the media processor has:
a media module information holding unit for holding in-use resource information in each of the operation modes of the plurality of media modules and required resource information in accordance with processing data information; and
an analyzing unit for acquiring, upon operation, the processing data information from the application, acquiring the in-use resource information and the required resource information from the media module information holding unit, selecting the operation mode of each of the media modules based on information acquired by examining idle resource information, and directing switching to the selected operation mode.

2. The media processing apparatus of claim 1, wherein the processing data information includes a format of stream data and a bit rate thereof.

3. The media processing apparatus of claim 1, wherein
the media processor further has an on-chip memory as an operation region for performing the media processings and
the in-use resource information and the required resource information include information on a capacity of the on-chip memory.

4. The media processing apparatus of claim 1, wherein the in-use resource information and the required resource information include information on a load on the media processor.

5. The media processing apparatus of claim 1, wherein the analyzing unit has, for each of the media modules, priority information when the mode is switched and determines a priority with which the operation mode is switched based on the priority information.

6. The media processing apparatus of claim 1, wherein the analyzing unit has:
a processing data acquiring portion for acquiring the processing data information from the application;
a source information acquiring portion for acquiring the in-use resource information and the required resource information from the media module information holding unit; and
a directing portion for selecting the operation mode of the media module and directing switching to the selected operation mode.

7. A media processing method using a media processing apparatus comprising:
a media processor having a plurality of media modules each for implementing a media processing function for each medium, a media module information holding unit for holding in-use resource information in each of operation modes of the plurality of media modules and required resource information in accordance with processing data information, and an analyzing unit; and
an application processor having an application for performing media processings by using the plurality of media modules, the media processing method comprising the steps of:
(a) causing the analyzing unit to acquire the processing data information;
(b) causing the analyzing unit to acquire the in-use resource information and the required resource information;
(c) causing the analyzing unit to select candidate operation modes for a switching target from within the media modules based on information acquired by examining idle resources; and
(d) causing the analyzing unit to select the operation mode from among the candidate operation modes for a switching target and direct switching to the selected mode.

8. The media processing method of claim 7, wherein the steps (a), (b), (c), and (d) are repeated for each of the media modules.

9. The media processing method of claim 7, wherein the step (d) is performed after the steps (a), (b), and (c) are performed for each of the plurality of media modules.

10. The media processing method of claim 7, wherein the analyzing unit has, for each of the plurality of media modules, priority information when the mode is switched and determines a priority with which the operation mode is switched based on the priority information.

11. The media processing method of claim 7, wherein the media processing apparatus further has:
a storage device for holding a program, wherein
the program implements the steps (a), (b), (c), and (d) by using a computer.
